(19) United States
(12) Patent Application Publication
(10) Pub. No.: US 2009/0191508 A1
(43) Pub. Date: Jul. 30, 2009

(54) MINI IMPLANT

(75) Inventors: Kyoung-Soo Choi, Busan (KR); Hong-Choel Yoon, Seoul (KR); Young-Seoung Jo, Gyeongsangnam-do (KR)

Correspondence Address: LUCAS & MERCANTI, LLP, 475 PARK AVENUE SOUTH, 15TH FLOOR, NEW YORK, NY, 10016, US

(73) Assignees: Kyoung-Soo Choi, Busan (KR); WARANTEC, Seoul (KR)

(21) Appl. No.: 12/358,651

(22) Filed: Jan. 23, 2009

(30) Foreign Application Priority Data
Jan. 25, 2008 (KR) 10-2008-0007959

(51) Int. Cl. A61C 8/00

(52) U.S. Cl. 433/174

(57) ABSTRACT

Disclosed herein is a mini implant. In the mini implant, friction is generated at a tapered portion through screw-coupling between a fixture's post portion and an abutment's post hole, so that the so-called friction-lock technique can be employed to not only completely couple the fixture and abutment without relying on cement or a mallet, but also uniformly maintain connectivity between the fixture and the abutment, regardless of the dental surgeon. The fixture defines the tapered portion at a top of an implanted portion defining screw threads in an outer periphery thereof. The post portion is formed above the tapered portion and defines screw roots. The abutment defines the post hole in a lower, inner region thereof and a prosthesis mount at an upper region thereof. The post hole defines screw threads corresponding to the screw roots of the post portion.

### CROSS-REFERENCES TO RELATED APPLICATION

This patent application claims the benefit of priority under 35 U.S.C. §119 from Korean Patent Application No. 10-2008-0007959 filed Jan. 26, 2008, the contents of which are incorporated herein by reference.

### BACKGROUND OF THE INVENTION

1. Field of the Invention

The present disclosure relates to a mini implant, and more particularly, to a mini implant in which friction is generated at a tapered portion through screw-coupling between a post portion of a fixture and a post hole of an abutment, so that the so-called friction-lock technique can be employed to not only complete the coupling of the fixture and abutment without relying on cement or a mallet, but also uniformly maintain connectivity between the fixture and the abutment, regardless of the dental surgeon.

2. Description of the Related Art

An implant in general denotes a replacement for restoring lost human tissue, and in the field of dentistry, denotes an artificially constructed dental root, or an endosseous implant used to implant a tooth root in an alveolar bone. Specifically, in order to replace a lost tooth, dental implant surgery involves implanting an artificial tooth root made of titanium (a material that the human body does not reject) in a maxilla or mandible from which a tooth has been lost, after which an artificial crown is fixed thereon to restore the function of the lost tooth.

While teeth or bone surrounding other types of prosthetics or false teeth degenerate over time, because implants are the same in terms of function and form as natural teeth, they do not induce degeneration of surrounding dental tissue, are not prone to cavities, and can be used almost indefinitely.

However, most permanent implants in use today require approximately from 2 to 4 months of healing time for osseointegration, following implantation in the alveolar bone.

To provide a more detailed description, after a typical permanent implant (as shown in FIG. 1) is implanted, because the diameter of an implant is normally 3.75 mm to 4 mm in consideration of factors such as fixing force for fixing in alveolar bone, the artificial crown cannot be installed immediately and must almost always be installed after a predetermined treatment period in which the alveolar bone around the implanted region heals and osseointegration with the surface of the permanent implant is completed.

Thus, a patient is rendered toothless for the treatment duration, which is undoubtedly a very difficult time for the patient who must endure loss of tooth function, a cosmetic deficit, pronunciation difficulties, and so forth.

When considering the above problems, if a temporary prosthesis were to be implanted during the predetermined period of treatment in which osseointegration on the surface of the permanent implant is completed following implantation of the permanent implant, a patent would not only be able to comfortably chew solid foods and suffer no pronunciation defects, but would also be socially unaffected in terms of outward appearance. In order to thus improve the quality of life for implant surgery patients, after natural teeth have been removed, implanting a mini implant having a predetermined circumference between a plurality of permanent implants that are adjacent to one another, and coupling a temporary prosthesis to the outside thereof is considered as a possible method.

Because a mini implant is used only temporarily for the predetermined treatment duration in which osseointegration on the surface of the permanent implant is completed, and must be removed after treatment, most mini implants are designed to have a diameter of 3.0 mm or less. However, the small diameter of a mini implant, as illustrated in FIG. 1, renders the coupling structure between the fixture and abutment of the permanent implant no longer usable. To provide a more detailed description with reference to FIG. 1, a permanent implant 10 is configured with a fixture 3 that is inserted in the alveolar bone to be osseointegrated, and an abutment 2 on which an artificial crown is fixed, where a retentive screw 1 is passed through the center of the abutment 2 to couple the same to the fixture 3. Conversely, because of its small diameter, a retentive screw cannot be used to couple a fixture to an abutment of a mini implant. Therefore, as illustrated in FIGS. 2A and 2B, in the related art, uni-body mini implants with integrally formed fixtures and abutments are used, or the fixture and abutment are coupled using cement (adhesive).

However, because a uni-body mini implant has an integrally formed fixture and abutment, an assortment of different mini implants according to head shape must be prepared, thus requiring procurement of an excessive number of mini implant types. For example, a removable prosthesis type mini implant with a ball-shaped head (as illustrated in FIG. 2A) for an artificial prosthesis to be inserted over and detachably fixed to, and a fixed prosthesis type mini implant with a post-shaped head (as illustrated in FIG. 2B) for an artificial prosthesis to be permanently fixed on must be prepared, and a large selection of both of the above types in different head sizes must be prepared. Thus, while a 2-piece mini implant provided with a separate fixture and abutment is more efficient, because related art 2-piece mini implants must have their fixtures and abutments coupled using cement (adhesive), the time for surgery is not only lengthened, but the coupling method is inconvenient and complicated, and removal of the mini implant is also made difficult.

Accordingly, as illustrated in FIG. 3, Korean Utility Model No. 20-417669 invented by the present inventor and entitled, “The Bonding Structure of the Provisional Implant”, which is included herein in its entirety by reference, discloses a temporary fixture 100 with a tapered head, and an abutment 200 defined with a press-fitting hole 201 into which the tapered head is press-fitted, to provide a temporary implant structure that couples the temporary fixture 100 to the abutment 200 by means of friction.

However, because a mallet must be used to fix the abutment according to the above registered utility model, the possibility is presented of the connectivity of the abutment varying greatly due to variables such as the weight of the mallet used and the methodology of the dental surgeon. That is, not only is the degree of preload (that initiates securing of the abutment) inconsistent, but much discomfort is derived from the shock ensuing from the required striking of the abutment with the mallet. Also, if the mallet cannot be properly used, installing of the abutment is made difficult. Thus, use of the above micro implant is limited to a large degree.

### SUMMARY OF THE INVENTION

Embodiments of the present invention are directed to provide a mini implant in which friction is generated at a tapered portion through screw-coupling between a post portion of a fixture and a post hole of an abutment, so that the so-called friction-lock technique can be employed to not only complete the coupling of the fixture and abutment without relying on cement or a mallet, but also uniformly maintain connectivity between the fixture and the abutment, regardless of the dental surgeon.

Embodiments of the present invention are also directed to provide a mini implant that allows easy replacement of an abutment regardless of the type of fixture, thus enabling selective use of a fixed prosthesis or a removable prosthesis according to requirements.

According to an aspect of the present invention, there is provided a mini implant including a fixture coupled with an abutment, wherein the fixture defines a tapered portion at a top of an implanted portion defining screw threads in an outer periphery thereof, and a post portion formed above the tapered portion and defining screw roots, and the abutment defines a post hole in a lower, inner region thereof and a prosthesis mount at an upper region thereof, the post hole defining screw threads corresponding to the screw roots of the post portion.

Because the present invention employs the friction-lock 5 technique to generate friction at the tapered portion through screw-coupling of the post portion of the fixture and the post hole of the abutment, the coupling structure of the fixture and abutment can be completed without the use of cement or a mallet, and the process can be performed very efficiently.

Also, because the degree of screw-coupling between the post portion of the fixture and the post hole of the abutment in the present invention can be visually checked during the process, the connectivity between the fixture and abutment can be maintained the same regardless of the dental surgeon.

Moreover, in the present invention, a screw-coupled abutment can easily be replaced regardless of whether the fixture has been implanted and its type, so that the type of artificial prosthesis to be fixed atop the abutment can be flexibly selected and used from a fixing prosthesis and a removable prosthesis, thereby maximizing the utility of the mini implant.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded frontal perspective diagram illustrating the structure of a permanent implant according to a related art;

FIGS. 2A and 2B are perspective diagrams illustrating uni-body mini implants according to the related art;

FIG. 3 is an exploded perspective diagram illustrating a mini implant according to the related art;

FIG. 4 is an exploded frontal perspective diagram of a mini implant according to the present invention;

FIG. 5 is a sectional diagram of a mini implant according to the present invention;

FIG. 6 is sectional diagram of an implant according to the present invention;

FIG. 7 is a plan diagram of a fixture according to the present invention;

FIGS. 8 and 9 are frontal perspective diagrams illustrating mini implants with differently-shaped abutments according to the present invention;

FIG. 10 is a frontal diagram illustrating various exemplary configurations of abutments that can be used for a mini implant according to the present invention; and

FIG. 11 is a diagram of a mini implant in use according to the present invention.

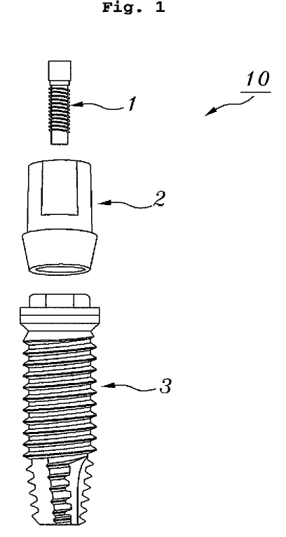

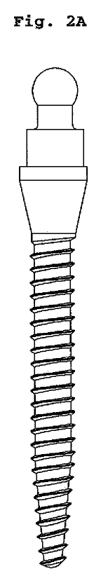

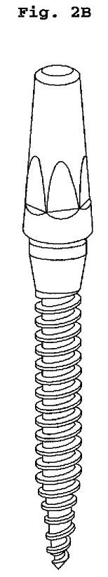

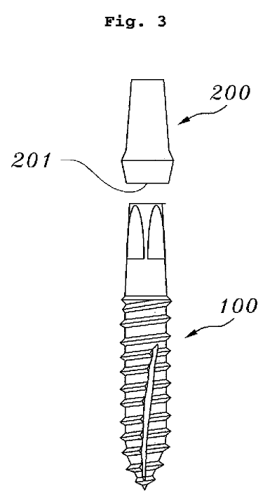

### DESCRIPTION OF THE PREFERRED EMBODIMENTS

Features and advantages of the present invention will be more clearly understood by the following detailed description of the present preferred embodiments by reference to the accompanying drawings. It is first noted that terms or words used herein should be construed as meanings or concepts corresponding with the technical spirit of the present invention, based on the principle that the inventor can appropriately define the concepts of the terms to best describe his own invention. Also, it should be understood that detailed descriptions of well-known functions and structures related to the present invention will be omitted so as not to unnecessarily obscure the important point of the present invention.

Hereinafter, specific embodiments of the present invention will be described in detail with reference to the accompanying drawings.

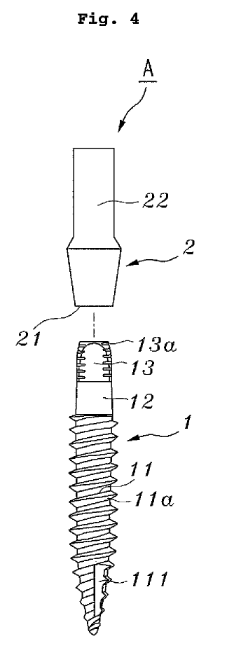

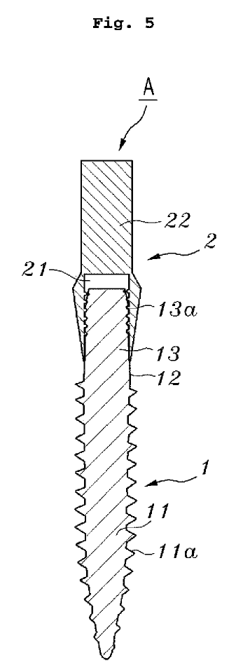

FIG. 4 is an exploded frontal perspective diagram of a mini implant according to the present invention, and FIG. 5 is a sectional diagram of a mini implant according to the present invention, where a mini implant A is configured with a fixture 1 coupled with an abutment 2.

First, the fixture 1 is formed with an implanted portion 11 defining a screw thread 11a in its outer periphery, and a tapered portion 12 above the implanted portion 11, where a post portion 13 defining screw roots 13a is formed at the top of the tapered portion 12.

As a portion that is implanted in osseous tissue of human alveolar bone, the implanted portion 11 defines a plurality of screw threads 11a in its outer periphery along a horizontal direction, so that when the implanted portion 11 is implanted, dentary bone fills the screw threads 11a during a treatment period for osseointegration.

Here, a cut portion 111 is defined in the lower screw threads 11a of the implanted portion 11. This is for allowing blood generated during the process of implanting the mini implant A in the osseous tissue of a patent to flow easily outward, and also for enabling bone to fill the front of the cut portion 111 of the fixture after implantation to effectively prevent movement of the mini implant A thereafter.

Further, the tapered portion 12 formed at the top of the implanted portion 11 is formed tapered to have a progressively decreasing diameter toward the top, and the tapered portion 12 is coupled via the post portion 13 formed on the top thereof, which is inserted in the post hole 21 of the abutment 2.

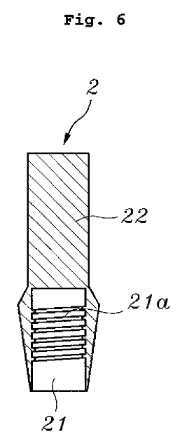

In addition, the abutment 2 defines the post hole 21 in the bottom thereof, and has a prosthesis mount 22 formed at the top thereof. As illustrated in FIG. 6, screw threads 21a are defined within the post hole 21 to correspond to the screw roots 13a of the post portion 13 of the fixture 1, and the lower portion of the post hole 21 is tapered so that the sectional diameter thereof progressively decreases in a downward direction.

Thus, the screw roots 13a defined in the post portion 13 are coupled with the screw threads 21a defined inside the post hole 21 of the abutment 2, and the top of the tapered portion 12 of the fixture 1 is press-fitted into the tapered section at the inner, bottom of the post hole 21 of the abutment 2 to couple the fixture 1 to the abutment 2.

Through the above coupling structure of the fixture 1 and the abutment 2, friction is first generated from screw-coupling between the screw roots 13a and screw threads 21a defined in the post portion 13 of the fixture 1 and the post hole 21 of the abutment 2, respectively, and secondary friction is generated through press-fitting of the top of the tapered portion 12 of the fixture 1 and the inner bottom of the post hole 21 of the abutment 2. Resultantly, the mini implant according to the present invention is structured to firmly couple the fixture 1 to the abutment 2 using only friction, so that even without the use of cement or a mallet, the coupling structure of the fixture and the abutment can be completed. Thus, the present invention can be determined to employ the friction-lock technique. In addition, when the degrees of taper of the tapered portion 12 of the fixture 1 and the inner, lower tapered section of the post hole 21 are made different, a cold wedding effect can be realized upon connection.

Further, because it is easy to visually determine the length that has been screw-coupled during the process of screw-coupling the abutment 2 to the fixture 1 in the present invention, the connectivity of the fixture and abutment can be uniformly maintained regardless of the level of skill of the surgeon.

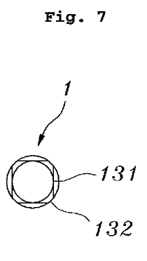

Also, as illustrated in FIG. 7, two or more of a flat portion 131 are formed on the post portion 13 of the fixture 1, and the flat portions 131 are formed perpendicular to a screw curved portion 132 defined by the screw roots 13a. The flat portions 131 are provided to enable the fixture 1 to be implanted in alveolar bone using a dental tool (not shown), and rotational torque can be applied to the fixture 1 by fixing the terminal end of the dental tool on two or more flat portions 131. While in embodiments of the present invention, there are four flat portions 131 formed, any number beyond two may be formed to facilitate use of a tool.

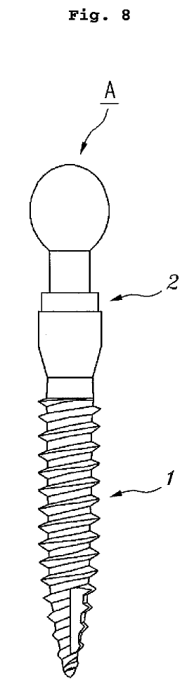

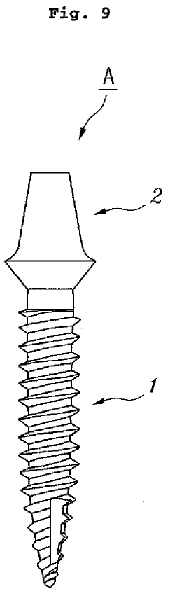

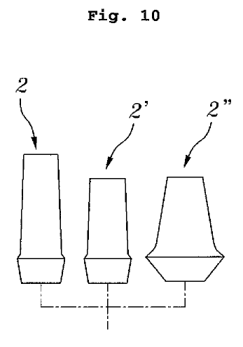

The upper part of the abutment 2 is configured as a prosthesis mount 22, and as illustrated in FIGS. 8 and 9, the prosthesis mount 22 may be formed in a ball shape or a post shape. Also, regardless of the shape of its prosthesis mount 22, an abutment 2 may be coupled and used with one type of provided fixture 1, and as illustrated in FIG. 10, the shapes of the prosthesis mounts 22 for the abutments 2, 2′, and 2″ may, or course, be formed greater or lower in height and width according to the part of a prosthesis to be formed thereon. Needless to say, abutments 2 with ball-shaped prosthesis mounts 22 may also be formed in various shapes.

Use of the present invention will be described below.

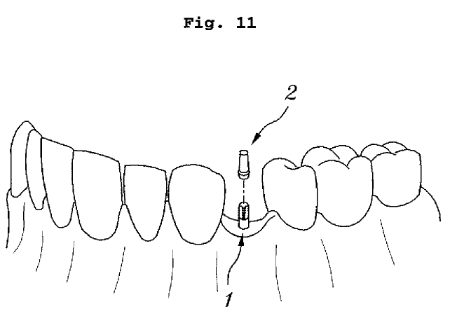

FIG. 11 is a diagram of a mini implant in use according to the present invention, where an implanted portion 11 of a fixture 1 is implanted in osseous tissue, and the tapered portion 12 and the post portion 13 are exposed above the gums. Then, when the post hole 21 that is the bottom, inner space of the abutment 2 is screw-coupled to the top of the fixture 1, friction from the screw-coupling and press-fitting at the tapered portion 12 fixes the abutment 2 to the fixture 1. Here, by checking the number of screw roots 13a defined in the post portion 13 or the length by which the abutment 2 has been screw-coupled in the fixture, the surgeon can easily determine the connectivity of the abutment 2.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A mini implant comprising a fixture coupled with an abutment, wherein
the fixture defines a tapered portion at a top of an implanted portion defining screw threads in an outer periphery thereof, and a post portion formed above the tapered portion and defining screw roots, and
the abutment defines a post hole in a lower, inner region thereof and a prosthesis mount at an upper region thereof the post hole defining screw threads corresponding to the screw roots of the post portion.

2. The mini implant as set forth in claim 1, wherein the post portion defines at least two or more flat portions perpendicular to a screw curved portion.

3. The mini implant as set forth in claim 1, wherein the prosthesis mount is provided in a ball configuration or a post configuration.

4. The mini implant as set forth in claim 1, wherein the post hole is tapered at an inner, lower region thereof to be press-fitted on the tapered portion.

5. The mini implant as set forth in claim 1, wherein the implanted portion of the fixture defines a cut portion in the screw threads at a lower region thereof.

6. The mini implant as set forth in claim 2, wherein the prosthesis mount is provided in a ball configuration or a post configuration.

7. The mini implant as set forth in claim 2, wherein the post hole is tapered at an inner, lower region thereof to be press-fitted on the tapered portion.

8. The mini implant as set forth in claim 2, wherein the implanted portion of the fixture defines a cut portion in the screw threads at a lower region thereof.
